(19) United States
(12) Patent Application Publication
(10) Pub. No.: US 2015/0096956 A1
(43) Pub. Date: Apr. 9, 2015

(54) BABY BOTTLE COVER WITH TACTILE STIMULATION DESIGN

(71) Applicants: Chia-Hung LIN, Taichung City (TW); Chan-Wei KUAN, Taichung City (TW)

(72) Inventors: Chia-Hung LIN, Taichung City (TW); Chan-Wei KUAN, Taichung City (TW)

(21) Appl. No.: 14/493,303

(22) Filed: Sep. 22, 2014

(30) Foreign Application Priority Data
Oct. 4, 2013 (TW) 102218593

(51) Int. Cl. A61J 9/06; A61J 9/08

(52) U.S. Cl. CPC A61J 9/06; A61J 9/08; A61J 2009/0623; A61J 2009/0669
USPC 215/11.6

(57) ABSTRACT

A baby bottle cover with tactile stimulation design is used to cover a baby bottle, the baby bottle includes a silicone case with an inner surface and an outer surface, and the inner surface defines an inner surface which conforms with the shape of the baby bottle. A plurality of the conical portions is integrally formed on the outer surface of the silicone case. When the baby holds the bottle, the soft conical portions formed on the outer surface of the baby bottle cover come into contact with the baby's hands to promote the development of baby's tactile sense.

### BACKGROUND OF THE INVENTION

1. Field of the Invention

The present invention relates to a baby bottle cover, and more particularly to a baby bottle cover with tactile stimulation design.

2. Description of the Prior Art

In the past, baby bottles are usually made of plastic material. However, plastic material, when heated, will release toxic substances, which causes safety concerns. Besides, plastic baby bottles have a low thermal insulation. Therefore, the current baby bottles are mostly made of glass. However, glass baby bottles are likely to break and hurt the baby. To solve this problem, a cloth made cover appeared on the market and is used to cover the glass bottle as a protection measure.

It is to be noted that a baby of five or six months old can be trained to hold the bottle, and the number of times that the baby uses the bottle is up to 6-7 times. Hence, the present invention provides a cover with tactile stimulation design for a baby bottle, which is capable of promoting the development of baby's tactile sense.

### SUMMARY OF THE INVENTION

The primary objective of the present invention is to provide a baby bottle cover with tactile stimulation design, wherein the baby bottle cover includes a soft bottle case which is made of food-grade silicone material and sleeved onto the glass baby bottle. When the baby holds the bottle, the soft conical portions formed on the outer surface of the baby bottle cover come into contact with the baby's hands to promote the development of baby's tactile sense.

To achieve the above objective, a baby bottle cover with tactile stimulation design is used to cover a baby bottle, the baby bottle includes a bottle portion, the bottle portion includes a bottle body, and the bottle body shrinks to form an opening. The baby bottle cover comprises a silicone case with an inner surface and an outer surface, and the inner surface defines an inner surface which conforms with the shape of the baby bottle. The silicone case further includes a bottom and a case opening defined by a contractile flange, the baby bottle is placed in the inner surface of the silicone case, in a manner that the contractile flange is sleeved onto the shrinkage section between the bottle body and the bottle opening. A plurality of the conical portions is integrally formed on the outer surface of the silicone case.

Preferably, the conical portions are circular cones to improve holding comfort. The conical portions have different heights, the relatively long conical portions provide a soft tactile feel, while the short conical portions provide a relatively rigid tactile feel, which allows the baby to feel tactile difference by touching different parts of the bottle cover, and intensifies the effect of tactile stimulation.

The silicone case covers the baby bottle, the conical portions are formed on the outer surface and located at the position between the bottom and the case opening of the silicone case, so that the silicone bottom allows the baby bottle to stand stably on a flat surface. Besides, the contractile flange is sleeved onto the shrinkage section between the bottle body and the bottle opening, so as to prevent the bottle sliding from the case opening and causing safety concern.

Preferably, the outer surface of the silicone case is provided with at least one blank area in which no conical portion is formed, the blank area is a zigzag area connected to the bottom and the contractile flange, and includes two folding points. Between the two folding points is a thumb-placing area used for placing of the baby's thumb, so that the baby bottle can be hold in a more stable manner.

### BRIEF DESCRIPTION OF THE DRAWINGS

FIG. 1 is an exploded view of a baby bottle cover with tactile stimulation design in accordance with the present invention;

FIG. 2 is a perspective view of the baby bottle cover with tactile stimulation design in accordance with the present invention;

FIG. 3 is a cross sectional view of the baby bottle cover with tactile stimulation design in accordance with the present invention;

FIG. 4 is a top view of the baby bottle cover with tactile stimulation design in accordance with the present invention;

FIG. 5 is a cross sectional view of a baby bottle cover with tactile stimulation design in accordance with another embodiment of the present invention;

FIG. 6 is an illustrative view showing the baby bottle cover with tactile stimulation design in accordance with the present invention is being held with a right hand; and

FIG. 7 is an illustrative view showing the baby bottle cover with tactile stimulation design in accordance with the present invention is being held with a left hand.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

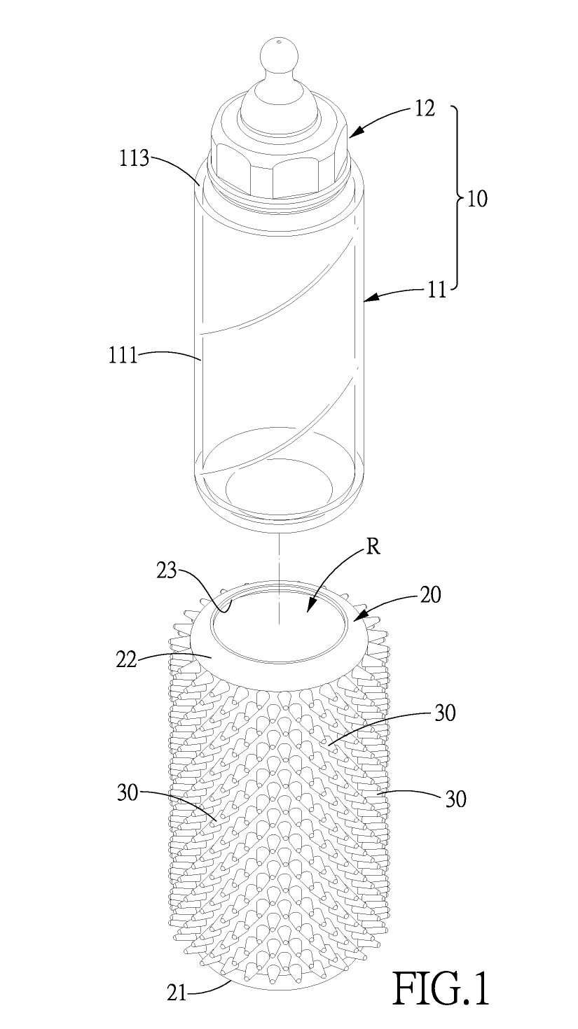

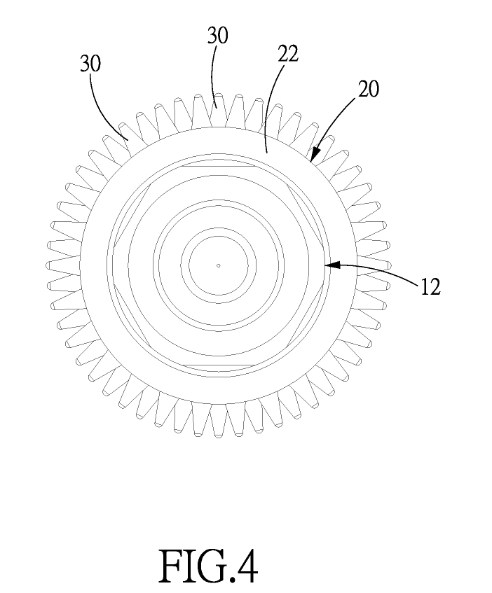

Referring to FIGS. 1-7, a baby bottle cover with tactile stimulation design in accordance with the present invention is shown.

The baby bottle cover is used to cover a baby bottle 10. The baby bottle 10 includes a bottle portion 11 and a nipple cap 12. The bottle portion 11 includes a bottle body 111, and the bottle body 111 shrinks to form an opening 112. Between the bottle body 111 and the bottle opening 112 is connected a shrinkage section 113. The baby bottle cover includes a silicone case 20 and a plurality of conical portions 30. The silicone case 20 includes an inner surface 201 and an outer surface 202. The inner surface 201 defines an inner surface R which conforms with the shape of the baby bottle 10. The silicone case 20 further includes a bottom 21 and a case opening 23 defined by a contractile flange 22. The baby bottle 10 is placed in the inner surface R of the silicone case 20, in such a manner that the contractile flange 22 is sleeved onto the shrinkage section 113 between the bottle body 111 and the bottle opening 112. The conical portions 30 are circular cones arranged on the outer surface 202 of the silicone case 20 in a staggered manner.

What mentioned above are the structures of the first embodiment of the present invention, for a better understanding of the invention, its operating advantages and the specific objects attained by its uses, reference should be had to the following descriptive matter.

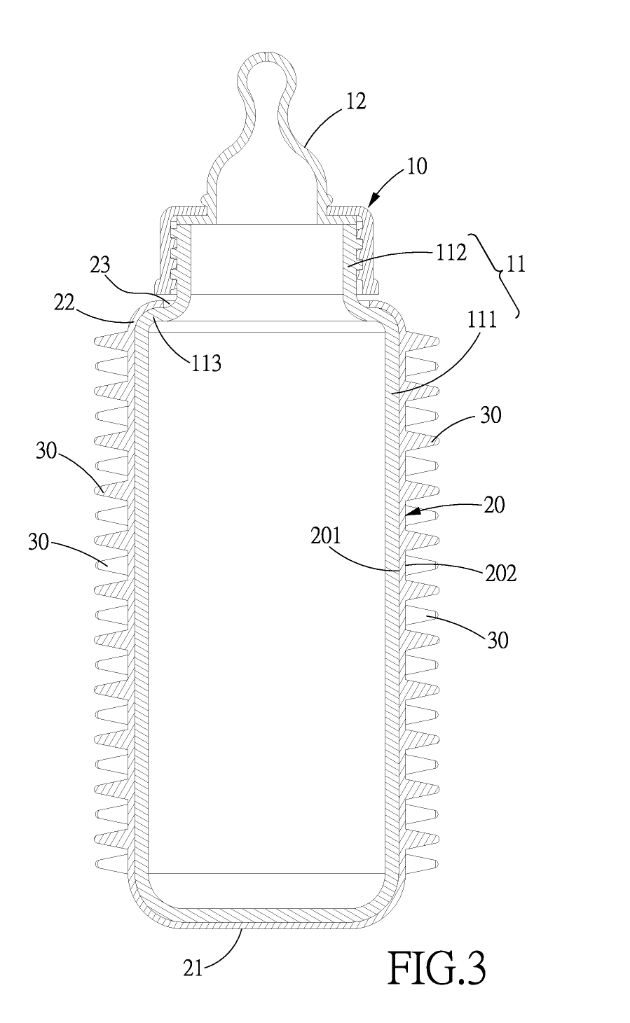

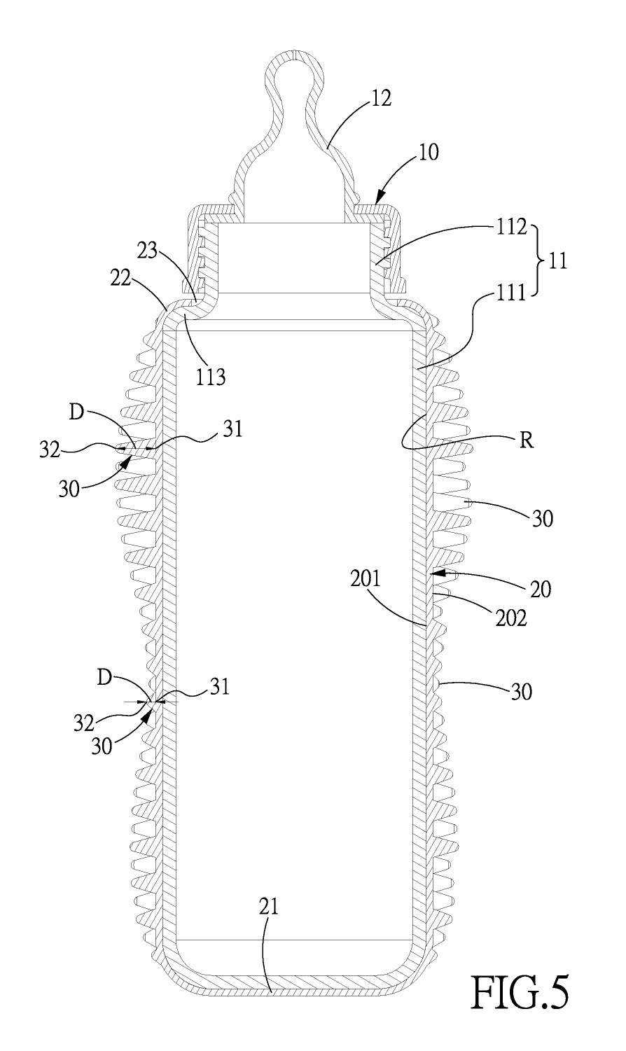

The baby bottle 10 is placed in the inner surface R of the silicone case 20, as shown in FIGS. 3 and 5, the conical portions 30 are formed on the outer surface 202 and located at the position between the bottom 21 and the case opening 23 of the silicone case 20. The position of the conical portions 30 is not limited to the above description. The conical portions 30 can also be located on the outer surface 202 and located at the position corresponding to the bottom 21 of the silicone case 20, so as to enhance the effect of tactile stimulation when the baby holds the baby bottle covered with the baby bottle cover with tactile stimulation design in accordance with the present invention. In addition, the baby bottle is normally held by the baby in an upside down manner. To prevent the bottle from sliding out of the silicone case 20 via the case opening 23, the elastic deformation capability of the silicone case allows the contractile flange 22 to be sleeved onto the shrinkage section 113 of the bottle body 111, which assuredly prevents the bottle sliding from the case opening 23 and causing safety concern.

To further improve the tactile stimulation effect, as shown in FIG. 5, each of the conical portions 30 includes a bottom portion 31 connected to the outer surface 202 of the silicone case 20 and a tapered end 32. Suppose that each of the conical portions 30 has a height D measured from the bottom portion 31 to the tapered end 32. The height D varies from 1.3 mm to 5 mm. The conical portions 30 are arranged by height alternatively in ascending and descending orders, namely, sequentially ascending from 1.3 mm to 5 mm, and then descending to 1.3 mm, so that the bottle case has a wavy shape. Since the conical portions 30 have different heights D, the relatively long conical portions 30 provide a soft tactile feel, while the short conical portions 30 provide a relatively rigid tactile feel, which allows the baby to feel tactile difference by touching different parts of the bottle cover, and intensifies the effect of tactile stimulation.

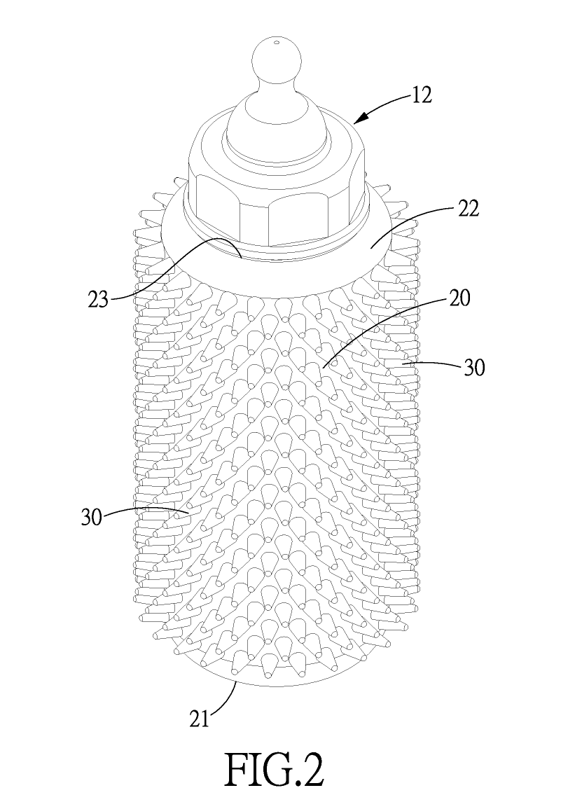

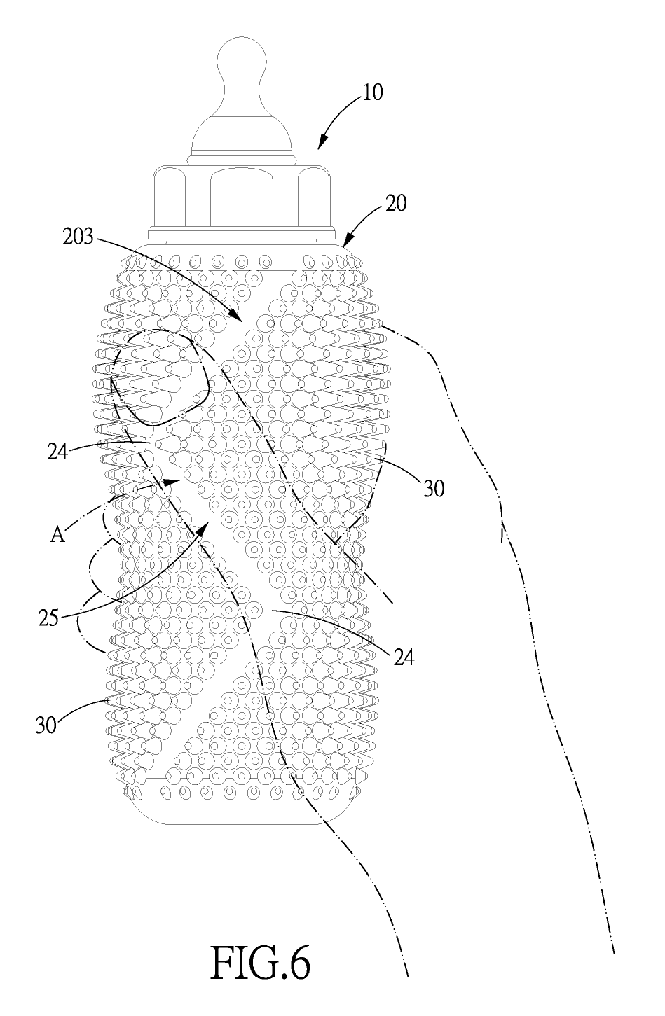

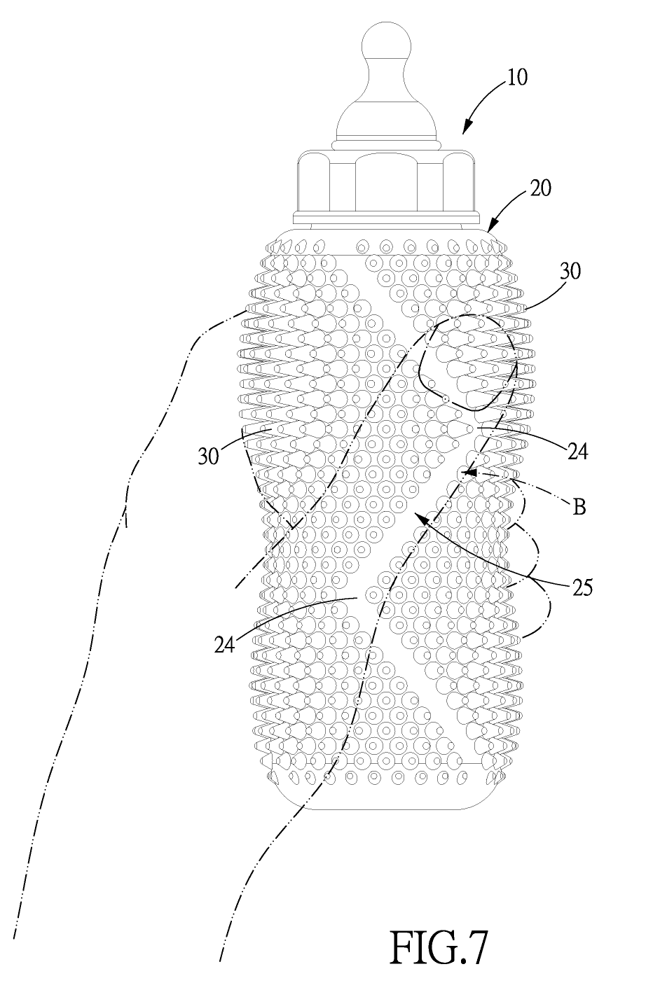

Referring then to FIGS. 2, 3 and 5-7 again, a baby bottle cover with tactile stimulation design in accordance with another embodiment of the present invention is as shown in FIG. 3, the outer surface 202 of the silicone case 20 is provided with at least one blank area 203 in which no conical portion 30 is formed. The blank area 203 is a zigzag area connected to the bottom 21 and the contractile flange 22, and includes two folding points 24. Between the two folding points 24 is a thumb-placing area 25. As shown in FIG. 6, the thumb-placing area 25 is a band-like area extending clockwise from bottom to top and used for placing of the baby's right thumb A. As shown in FIG. 7, the thumb-placing area 25 is a band-like area extending counterclockwise from bottom to top and used for placing of the baby's left thumb B.

It is to be noted that the present invention can be provided with one blank area 203, or 3-5 blank areas 203, as shown in FIGS. 3-5. When there is only one blank area 203, the thumb-placing area 25 can be formed in the shape as shown in FIG. 6 for placing of the baby's right thumb, or in the shape as shown in FIG. 7 for placing of the left thumb. If the silicon case 20 is provided with several blank areas, the thumb-placing areas 25 can be arranged alternatively in the forms of the shapes as shown in FIGS. 6 and 7, respectively, which allows the baby to hold the baby bottle with both hands, and both left and right thumbs can be placed in the thumb-placing areas 25, so that the baby bottle can be held in a more stable manner.

In conclusion, the baby bottle cover with tactile stimulation design in accordance with the present invention can use the conical portions 30 formed on the outer surface of the bottle cover to stimulate the baby's tactile sense. Besides, the bottle cover is a unitary structure made of silicone material, which has the advantages of high-temperature resistance, protecting the glass baby bottle, and reducing the use of plasticizing agent.

While we have shown and described various embodiments in accordance with the present invention, it is clear to those skilled in the art that further embodiments may be made without departing from the scope of the present invention.

What is claimed is:

1. A baby bottle cover with tactile stimulation design used to cover a baby bottle, the baby bottle including a bottle portion, the bottle portion including a bottle body, and the bottle body shrinks to form an opening;
wherein the baby bottle cover comprises a silicone case with an inner surface and an outer surface, the inner surface defines an inner surface which conforms with the shape of the baby bottle, the silicone case further includes a bottom and a case opening defined by a contractile flange, the baby bottle is placed in the inner surface of the silicone case, in a manner that the contractile flange is sleeved onto the shrinkage section between the bottle body and the bottle opening;
and a plurality of the conical portions are integrally formed on the outer surface of the silicone case.

2. The baby bottle cover with tactile stimulation design as claimed in claim 1, wherein the conical portions are circular cones arranged on the outer surface of the silicone case in a staggered manner.

3. The baby bottle cover with tactile stimulation design as claimed in claim 1, wherein each of the conical portions includes a bottom portion connected to the outer surface of the silicone case and a tapered end, each of the conical portions has a height measured from the bottom portion to the tapered end, the height varies from 1.3 mm to 5 mm, and the conical portions are arranged by height alternatively in ascending and descending orders, so that the baby bottle case has a wavy shape.

4. The baby bottle cover with tactile stimulation design as claimed in claim 1, wherein the baby bottle includes a bottle portion and a nipple cap.

5. The baby bottle cover with tactile stimulation design as claimed in claim 1, wherein the outer surface of the silicone case is provided with at least one blank area in which no conical portion is formed, the blank area is a zigzag area connected to the bottom and the contractile flange, and includes two folding points, and between the two folding points is a thumb-placing area.

6. The baby bottle cover with tactile stimulation design as claimed in claim 5, wherein the thumb-placing area is a band-like area extending clockwise from bottom to top and used for placing of the baby's right thumb.

7. The baby bottle cover with tactile stimulation design as claimed in claim 5, wherein the thumb-placing area is a band-like area extending counterclockwise from bottom to top and used for placing of the baby's left thumb.

8. The baby bottle cover with tactile stimulation design as claimed in claim 5, wherein the quantity of the blank areas is 3-5, thumb-placing areas between the blank areas are arranged alternatively and extend clockwise and counterclockwise from bottom to top, respectively, which allows the baby's both left and right thumbs to placed in the thumb-placing areas.
